(19) United States
(12) Patent Application Publication
(10) Pub. No.: US 2023/0123937 A1
(43) Pub. Date: Apr. 20, 2023

(54) RESIDUAL CURVATURE METHOD TO MITIGATE PIPELINE BUCKLING

(71) Applicant: Equinor Energy AS, Stavanger (NO)

(72) Inventor: Geir ENDAL, Stavanger (NO)

(73) Assignee: Equinor Energy AS, Stavanger (NO)

(21) Appl. No.: 17/913,930

(22) PCT Filed: Jan. 29, 2021
(86) PCT No.: PCT/NO2021/050027

§ 371 Date: Sep. 23, 2022

(30) Foreign Application Priority Data
Mar. 25, 2020 (GB) 2004338.6

(51) Int. Cl. F16L 1/18; F16L 1/20

(52) U.S. Cl. CPC F16L 1/18; F16L 1/203

(57) ABSTRACT

A method for laying a pipeline on a seabed in order to provide controlled thermal expansion includes feeding the pipeline from a pipeline reel through a straightener system; and at the straightener system, imparting an alternating and continuously varying degree of residual curvature on at least a portion of the pipeline.

### TECHNICAL FIELD

The invention relates to a method and apparatus for mitigating global buckling of subsea pipelines by allowing the controlled thermal expansion of said pipelines.

### BACKGROUND

Subsea pipelines typically carry oil and gas from a well from a wellhead towards a processing facility. When the internal temperature of the pipeline increases (e.g. during a start-up cycle), the pipeline will thermally expand. As a result, the pipeline will be exposed to axial compressive forces, which may cause the pipeline to buckle. This effect is known as global buckling. It is common practice to control global buckling by restraining the pipeline by some means, either by placing the pipeline in a ditch and/or covering it with gravel in order to keep it in place. Alternatively, global buckling may be intentionally triggered in a controlled manner, e.g. by intermittent rock installation, snake-lay, vertical upset, local weight reduction, zero-radius bends and/or pre-bent sections. A problem with these existing methods—in addition to being costly—is that typically the pipeline deflects at localized locations intermittently spaced along the length of the pipeline. As a result, the stresses and fatigue loading may become detrimental to the pipeline at these locations—particularly as a result of start-up or shut-down cycles when changes in the internal pressure and temperature are largest.

A method that recently has grown popular to control global buckling is described in EP-1358420-B1, wherein a straightener is used to create portions with residual curvature intermittently spaced along the pipeline during offshore installation using the reel-lay method. However, implementation of this method may result in strain localization at the beginning and the end of each residual curvature portion, because implementation is normally performed by adjusting the straightener settings whilst the vessel is at an all-stop at the beginning and the end of every residual curvature portion. This is not only time consuming, but also results in locally high stresses and high fatigue loading, especially in case of start-up or shut-down cycles.

Another problem with existing technology is that there are various components that may cause stress concentrations at the point which they are attached to the pipeline (e.g. anode attachment pads, buckle arrestors and J-collars). As such, the points at which these components are attached are prone to excessive fatigue loading, and are particularly at risk if located at pipeline buckling locations.

In light of the above, there is a need for an improved way to control thermal expansions and mitigate the global buckling of subsea pipelines.

### STATEMENT OF INVENTION

According to a first aspect of the invention there is provided a method for laying a pipeline on a seabed in order to provide controlled thermal expansion, comprising feeding the pipeline from a pipeline reel through a straightener system, and at the straightener system, imparting an alternating and continuously varying degree of residual curvature on at least a portion of the pipeline.

In some embodiments, said portion of the pipeline forms a wave-shape.

In some embodiments, the pipeline has an initial radius of curvature, and imparting an alternating and continuously varying degree of residual curvature on at least a portion of the pipeline comprises applying a continuously varying radius of counter curvature to at least a portion of the pipeline, in a direction opposing the initial radius of curvature.

In some embodiments, applying a continuously varying radius of counter curvature to at least a portion the pipeline comprises continuously alternating between over-straightening and under-straightening the pipeline with respect to the initial radius of curvature, such that the pipeline comprises alternating over-straightened sections and under-straightened sections.

In some embodiments, the over-straightened sections and under-straightened sections are approximately equal in length. Alternatively, the under-straightened sections may be longer than the over-straightened sections.

In some embodiments, the pipeline is under-straightened with respect to the initial radius of curvature.

In some embodiments, the method further comprises, at the straightener system, creating one or more straight portions of pipeline in between portions of the pipeline having the alternating and continuously varying degree of residual curvature.

In some embodiments, the method further comprises attaching one or more components which cause a stress concentration to said one or more straight portions. Said components which cause a stress concentration may include anode attachment pads, buckle arrestors, or J-collars.

In some embodiments, each of the one or more straight portions has a predetermined length in the range 10 m to 500 m.

In some embodiments, the portions of the pipeline having the alternating and continuously varying degree of residual curvature have a repeating pattern with a wavelength in the range 25 m to 70 m.

According to a second aspect of the invention there is provided an apparatus for laying a pipeline on a seabed in order to provide controlled thermal expansion, comprising a straightener system configured to receive a pipeline from a pipeline reel and impart a residual curvature on said pipeline; and a controller unit for controlling the degree of said residual curvature imparted by the straightener system, such that the straightener system imparts an alternating and continuously varying degree of residual curvature on at least a portion of the pipeline.

### FIGURES

The invention will now be described in more detail and, by way of example only, with reference to the accompanying drawings, in which:

FIG. 1 shows a side view of a vessel for offshore pipeline laying, provided with a pipeline reel and straightener system;

FIGS. 2A to 2C illustrate portions of a subsea pipeline deformed to have a continuously varying and alternating degree of residual curvature;

FIGS. 3A to 3C each illustrate the vessel of FIG. 1 in the process of laying a pipeline; and

FIG. 4 illustrates part of a subsea pipeline having both a straight portion and portions with a continuously varying and alternating residual curvature.

### DETAILED DESCRIPTION

The inventor has realised that a way to minimise displacements, stresses and fatigue loading of a pipeline at risk of global buckling is to maximise the number of locations that deflect laterally. The solution described herein is to deform the pipeline to create portions of pipeline having a continuously varying and alternating degree of residual curvature, allowing thermal expansion to be shared amongst a high number of locations with lateral deflection (i.e. via incremental expansion in each curved portion, or at least across a large number of portions). In this way, a small amount of expansion is absorbed at each location deflecting laterally. In other words, the residually curved pipeline has significantly reduced axial stiffness, due to which build-up of large compression forces is correspondingly reduced, and hence global buckling under increased operating loads (pressure and temperature) is controlled or even avoided.

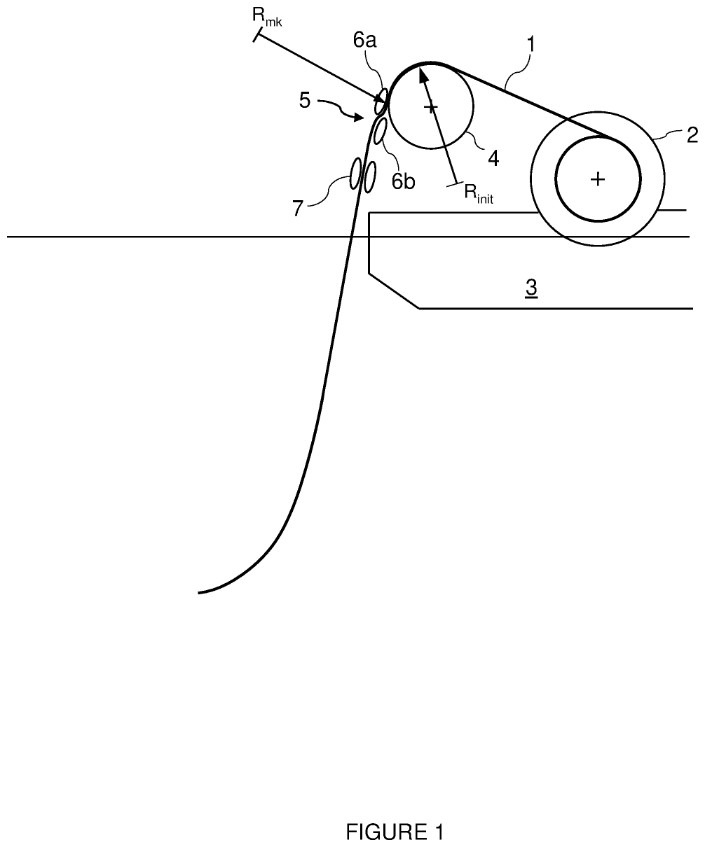

During offshore installation, a pipeline is laid from a vessel using a reel-lay method, as shown in FIG. 1. Initially, the pipeline 1 is coiled onto a reel 2 on the vessel 3. The pipeline 1 is fed out from the reel 2, and runs over an aligner wheel 4 at the top of a lay ramp. The pipeline 1 is plastically deformed over the aligner wheel 4 to have an initial radius of curvature Rᵢₙᵢₜ, since the aligner wheel 4 has a radius of curvature less than the pipeline's elastic radius of curvature. In order to remove the plastic deformation, the pipeline 1 runs through a straightener system 5.

In the example shown in FIG. 1, the straightener system 5 includes an upper track 6a and lower track 6b. The upper track 6a is arranged on the upper side of the pipeline 1 and the lower track 6b is arranged on the underside. Straightening of the pipeline 1 occurs as it runs through a three-point reversed bending, supported by the aligner wheel 4, the upper track 6a and the lower track 6b. In this way, a radius of counter curvature Rₘₖ is added to the opposite side of the pipeline 1 with respect to the initial radius of curvature Rᵢₙᵢₜ, to create a degree of residual curvature. The positions of the upper track 6a and/or lower track 6b in the straightener system 5 are hydraulically adjustable, and generation of the residual curvature can be facilitated by varying/adjusting the position of the upper track 6a and/or lower track 6b. The position of the aligner wheel 4 may also be hydraulically adjustable. In some embodiments, after passing through the upper 6a and lower 6b tracks, the pipeline 1 is fed through a tensioner 7.

Preferably, a controller unit (not shown) is connected to the straightener system 5, allowing the degree of residual curvature provided by the straightener system 5 to be varied as the pipeline 1 is laid out. The controller unit may be coupled to any of the components of the straightener system 5 (i.e. to the upper track 6a, lower track 6b and/or aligner wheel 4), but would typically most easily be connected to the upper track 6a In any case, the controller unit is programmed or otherwise controlled such that a continuously varying and alternating degree of straightening is performed as the pipeline 1 is laid out. In this way, a wave-shaped pipeline is created (rather than the straight shape shown in FIG. 1), and thermal expansion can be absorbed as incremental deflections and stresses distributed along the pipeline.

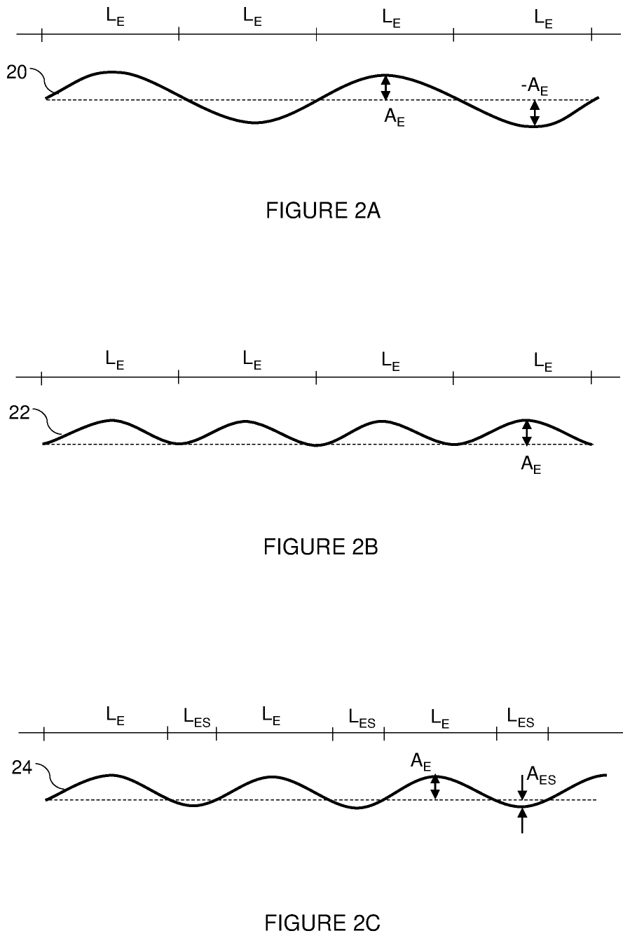

The wave-shape may have different forms. For example, the pipeline may be deformed in an approximately sinusoidal shape 20, as shown in FIG. 2A. The sinusoidal shape is formed by symmetrically alternating between over- and under-straightening the pipeline during installation. By “over-straightening”, typically it is meant that the upper track 5a is moved downwards so that radius of counter curvature Rₘₖ opposes the initial radius of curvature Rᵢₙᵢₜ, forming a residual curvature in the opposite direction to the initial curvature. Likewise, by “under-straightening”, it is typically meant that the upper track 5a is moved downwards to form a residual curvature the same direction as the initial curvature (but to a lesser extent). The dotted line in FIG. 2A indicates the line of exact straightening (i.e. where the radius of counter curvature Rₘₖ effectively ‘cancels out’ the initial radius of curvature Rᵢₙᵢₜ).

In FIG. 2A, the pipeline is deformed such that the wave-shape is an approximately sinusoidal shape 20, having a wavelength of an approximately constant length L_{E}. The amplitude of the sine wave is A_{E}. Due to the symmetrical alternation between over- and under-straightening, the amplitude A_{E} of the wave-shape 20 is approximately constant along the length of the deformed pipeline. This symmetric wave-shape 20 may be advantageous to the operational behaviour and to control global buckling. However, it may be challenging from an installation point of view, as the repeated over-straightening may impose excessive loads on the lay system.

Alternatively, the pipeline may be deformed into a wave-shape 22 as shown in FIG. 2B, by continuously under-straightening the pipeline (with respect to the initial radius of curvature) in an alternating pattern. The degree of under-straightening is varied so that the degree of residual curvature alternates continuously between a minimum and a maximum. At points of maximum under-straightening, the wave-shape 22 has a maximum amplitude A_{E}. Conversely, at minimum under-straightening, the pipeline approaches exact straightening (i.e. the point where the pipeline is neither under- nor over-straightened, as indicated by the dotted line). In other words, in FIG. 2B, no over-straightening is required, and the residual curvature alternates continuously within the under-straightened regime. Advantageously, in this way, the initial curvature inherited from the aligner wheel 4 (or the reel 2) may be exploited, reducing the load on the straightener system 5.

Alternatively, as shown in FIG. 2C, the pipeline may be deformed into a non-symmetrical wave-shape 24, which alternates continuously and asymmetrically between under-straightening and slight over-straightening. In other words, the degree of straightening is varied to create a difference in the amplitude between the neighbouring peaks and troughs of the wave-shape 24. The under-straightened amplitude A_{E} exceeds the over-straightened amplitude A_{ES}. Correspondingly, the over-straightened sections have length L_{ES}, and the under-straightened sections have length L_{E}, wherein L_{E} is longer than L_{ES}.

Having a maximal straightening degree of exact straightening (FIG. 2B), or a slight over-straightening (FIG. 2C) may be advantageous from an installation point of view, in order not to impose excessive loads on the lay system.

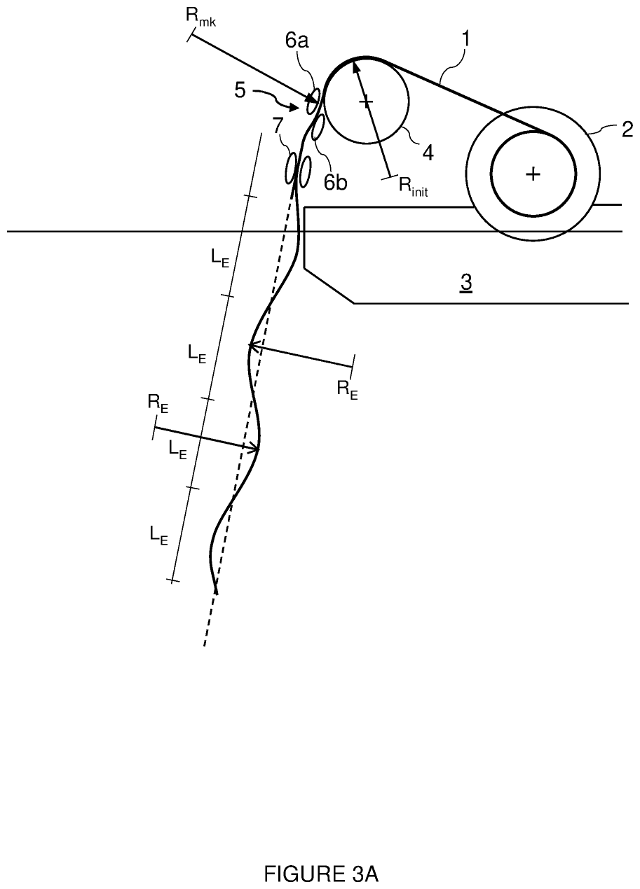

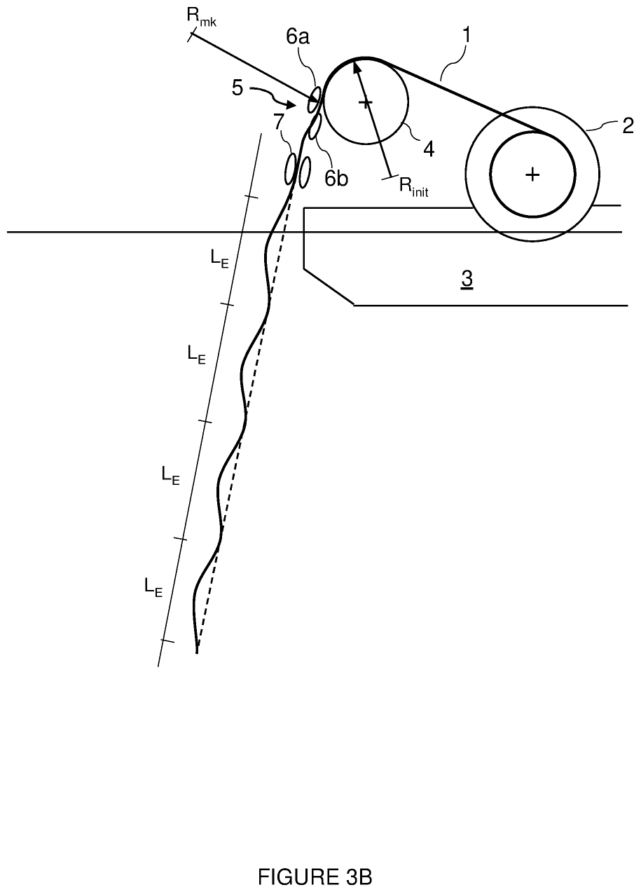

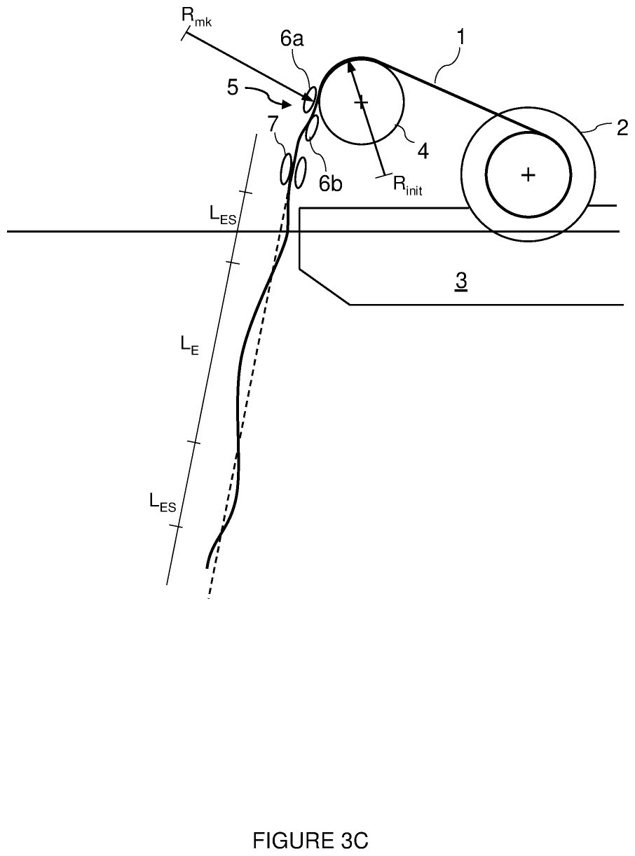

FIG. 3A illustrates part of a pipeline being laid out using the apparatus of FIG. 1, to form the symmetric wave-shape of FIG. 2A. After passing through the straightener system 5, the pipeline 1 has a minimum residual radius of curvature R_{E} approximately at the peaks of the sine wave. Similarly, FIGS. 3B and 3C illustrate part of a pipeline being laid out to form the asymmetric wave-shapes as described in connection with FIGS. 2B and 2C, respectively. It should be understood that FIGS. 3A to 3C are not to scale, and that the amplitudes and curvatures have been exaggerated so that the residual curvature can be clearly seen.

The present invention has a number of advantages. Firstly, as the curvature is varied continuously by the controller unit, installation is quicker and cheaper than implementation of intermittent portions without a controller unit as described EP-1358420-B1, since the former can be implemented with the installation vessel installing the pipeline continuously, without having to periodically stop the vessel. In contrast, the latter requires all-stop on the vessel at the beginning and end of each intermittent portion. Furthermore, implementation of a continuous alternating residual curvature by adjusting the straightener settings (without stopping the vessel) ensures that the local stress-strain concentrations as seen when implementing the method of EP-1358420-B1 are avoided. Furthermore, as the pipeline continuously has a varying residual curvature, there is no need to know the straightener settings for a straight pipeline required for exact straightening, meaning that the invention may eliminate the need to perform costly straightening trials. Advantageously, the invention described herein is also capable of dealing with locally varying seabed conditions over time (e.g. build-up of sand waves, local burial, etc.), in the sense that the pipeline will deflect wherever is more convenient, ensuring that the pipeline is always at a relaxed condition.

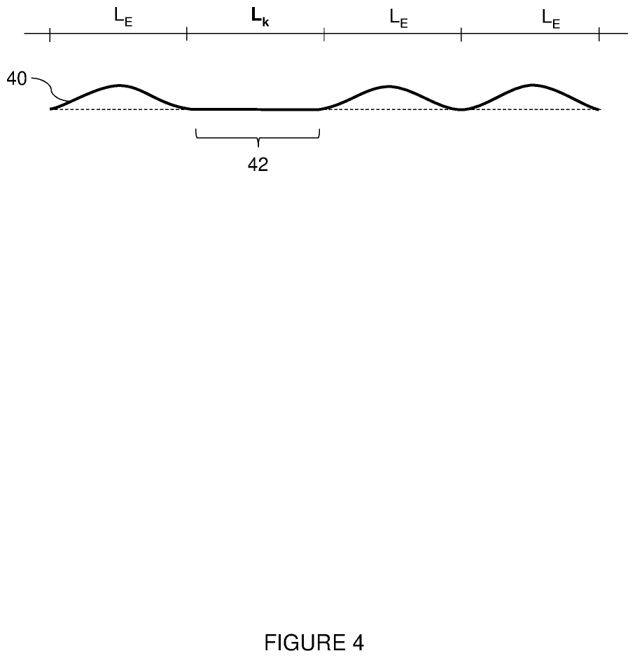

In an alternative embodiment, a variation of the invention is to control the straightener system settings to include one or more straight portions in the pipeline, for attachment of components that cause stress concentrations. The straight portions are provided in between the portions having continuously varying and alternating residual curvature (described as “curved portions” hereafter for brevity). FIG. 4 shows a pipeline 40 deformed to have a straight portion 42 in between curved portions. The straight portion 42 has a predetermined length L_{K} and the curved portions have a predetermined length L_{E} over which the alternating pattern repeats (i.e. L_{E} can be considered as the wavelength). The optimal wavelength L_{E} is typically in the range 25 m to 70 m, but will depend on the pipe stiffness (which varies with the pipe diameter and wall thickness).

For example, a 10″ diameter pipe would typically have L_{E} in the range 25 to 40 m, whilst a 16″ pipe would typically have L_{E} in the range 40 to 70 m.

While L_{K} and L_{E} are shown to be approximately equal in FIG. 4, L_{K} can be any suitable length, appropriate to the component(s) being attached. For example, L_{K} may typically be from 10 m long, up to approximately 500 m long in the case of in-line structures. Various components that may cause stress concentrations are known in the art, such as anode attachment pads, buckle arrestors and J-collars. Advantageously, by attaching these components in said straight portions, they are attached away from locations most at risk of undergoing buckling (i.e. outside of the curved portions).

In FIG. 4, the residually curved parts of the pipeline in the under-straightened regime (as described in connection with FIG. 2B), by way of example only. The straight sections may also be included when the pipeline is symmetrically under- and over-straightened (FIG. 2A), or asymmetrically under-straightened (FIG. 2C).

Although the invention has been described in terms of exemplary embodiments, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A method for laying a pipeline on a seabed in order to provide controlled thermal expansion, comprising:
feeding the pipeline from a pipeline reel through a straightener system; and
at the straightener system, imparting an alternating and continuously varying degree of residual curvature on at least a portion of the pipeline.

2. The method of claim 1, wherein said portion of the pipeline forms a wave-shape.

3. The method of claim 1, wherein the pipeline has an initial radius of curvature, and wherein imparting an alternating and continuously varying degree of residual curvature on at least a portion of the pipeline comprises:
applying a continuously varying radius of counter curvature to at least a portion of the pipeline, in a direction opposing the initial radius of curvature.

4. The method of claim 3, wherein applying a continuously varying radius of counter curvature to at least a portion the pipeline comprises:
continuously alternating between over-straightening and under-straightening the pipeline with respect to the initial radius of curvature, such that the pipeline comprises alternating over-straightened sections and under-straightened sections.

5. The method of claim 4, wherein the over-straightened sections and under-straightened sections are approximately equal in length.

6. The method of claim 4, wherein the under-straightened sections are longer than the over-straightened sections.

7. The method of claim 3, wherein the pipeline is under-straightened with respect to the initial radius of curvature.

8. The method of claim 1, further comprising:
at the straightener system, creating one or more straight portions of pipeline in between portions of the pipeline having the alternating and continuously varying degree of residual curvature.

9. The method of claim 8, further comprising:
attaching one or more components which cause a stress concentration to said one or more straight portions.

10. The method of claim 9, wherein said components which cause a stress concentration include: anode attachment pads, buckle arrestors, or J-collars.

11. The method of claim 8, wherein each of the one or more straight portions has a predetermined length in the range 10 m to 500 m.

12. The method of claim 8, wherein the portions of the pipeline having the alternating and continuously varying degree of residual curvature have a repeating pattern with a wavelength in the range 25 m to 70 m.

13. An apparatus for laying a pipeline on a seabed in order to provide controlled thermal expansion, comprising:
a straightener system configured to receive a pipeline from a pipeline reel and impart a residual curvature on said pipeline; and
a controller unit for controlling the degree of said residual curvature imparted by the straightener system, such that the straightener system imparts an alternating and continuously varying degree of residual curvature on at least a portion of the pipeline.

14. The method of claim 2, further comprising:
at the straightener system, creating one or more straight portions of pipeline in between portions of the pipeline having the alternating and continuously varying degree of residual curvature.

15. The method of claim 3, further comprising:
at the straightener system, creating one or more straight portions of pipeline in between portions of the pipeline having the alternating and continuously varying degree of residual curvature.

16. The method of claim 4, further comprising:
at the straightener system, creating one or more straight portions of pipeline in between portions of the pipeline having the alternating and continuously varying degree of residual curvature.

17. The method of claim 5, further comprising:
at the straightener system, creating one or more straight portions of pipeline in between portions of the pipeline having the alternating and continuously varying degree of residual curvature.

18. The method of claim 6, further comprising:
at the straightener system, creating one or more straight portions of pipeline in between portions of the pipeline having the alternating and continuously varying degree of residual curvature.

19. The method of claim 7, further comprising:
at the straightener system, creating one or more straight portions of pipeline in between portions of the pipeline having the alternating and continuously varying degree of residual curvature.
